(19) United States
(12) Patent Application Publication
(10) Pub. No.: US 2018/0057984 A1
(43) Pub. Date: Mar. 1, 2018

(54) TECHNICAL PACKAGING MATERIAL

(71) Applicant: Carl Freudenberg KG, Weinheim (DE)

(72) Inventor: Robert Groten, Sundhoffen (FR)

(21) Appl. No.: 15/659,644

(22) Filed: Jul. 26, 2017

(30) Foreign Application Priority Data
Aug. 25, 2016 (DE) 10 2016 010 163.6

(51) Int. Cl. D04H 3/16; B32B 5/02; B32B 37/04; D01D 5/08; B65D 65/38

(52) U.S. Cl. CPC D04H 3/16; B32B 5/022; B32B 2553/00; D01D 5/08; B65D 65/38; B32B 37/04

(57) ABSTRACT

The invention relates to the use of a microfilament fabric comprising at least one layer A which comprises a fiber component in the form of microfilaments, which are laid down to produce a nonwoven and are bonded by jets of fluid, and have an average titer of less than 0.15 dtex, in the form of melt-spun microfilaments which are laid down to produce a nonwoven, and/or in the form of composite filaments which are split and bonded by fluid-jet bonding at least to some extent to produce elementary filaments having an average titer of less than 0.15 dtex, as a technical packaging material. The invention also relates to a microfilament composite fabric which comprises a microfilament fabric of this type, and also relates to a method for the production thereof.

### CROSS-REFERENCE TO RELATED APPLICATIONS

Priority is claimed to German Patent Application No. DE 10 2016 010 163.6, filed on Aug. 25, 2016, the entire disclosure of which is hereby incorporated by reference herein.

### FIELD

The invention relates to the use of a microfilament fabric as a technical packaging material. The invention also relates to a technical packaging material which contains the microfilament fabric, and also to a method for the production thereof.

### BACKGROUND

For articles having a delicate surface, such as a painted outer surface, there is a risk of this surface being damaged during transport. Superficially delicate components in automobile production have to be transported from one work station to the next, which always involves the risk of damage.

For example, the production of car bumpers comprises the following work stations: in a first work station, the metal bumper bar is produced. In a second work station, the bumper bar is provided with a plastics surface. The assemblage is provided with colored paints in one or more painting stations and is then overpainted in a transparent manner in a further work station. During each transition from one work station to the next, it must be ensured that the component is not damaged, because otherwise the high-quality surface has to be reproduced. If the damage is relatively serious, the high-quality surface can no longer be repaired. Accordingly, it is then no longer possible to continue using the component as a whole. The costs which are incurred due to this type of damage are considerable.

To reduce the risk of damage, attempts have been made to apply to the surfaces of these components an adhesive film which is then removed after the component has been assembled on the associated vehicle. However, in the case of complexly formed components, this type of attachment and subsequent removal of an adhesive film is laborious, if not completely impossible. Moreover, an adhesive film of this type is generally unsuitable for components which have a high inherent weight. The generally thin adhesive film is ruptured if such heavy components strike an obstacle.

Better protection is provided by technical packaging materials which are used for encasing the components, for example as protection during assembly and transportation, and which should thus reduce the risk of soiling or damage during production. In this respect, the packaging material has to satisfy substantially two requirements, firstly to ensure adequate protection against external mechanical stress and secondly to ensure adequate protection in respect of various dirt particles, such as dust, possibly oil or other liquids.

Technical packaging materials are used for all kinds of superficially delicate articles, such as painted car body parts, painted furniture (e.g. piano finish), paintings, glasses, glass lenses, containers which are chrome-plated or are otherwise finished with a high gloss.

Technical packaging materials often contain coarse-fiber fabrics. These have the disadvantage that broken fibers can lead to paint defects (see below). The fabrics are mostly based on cotton-polyester blends and are generally colored to facilitate content recognition, and they are usually coated with PVC. An advantage of the PVC coating is that it can be cleaned effectively (high-pressure water jet). However, it does not allow final evaporation of the paint solvent, which can result in circular spots on the bumper, in a similar way to the mark left behind on a wooden table by a drinking glass. However, not using the PVC coating can bring the disadvantage of contaminants from the production process (for example bits of metal from the bumper preparation) settling into the fabric, which results in scratches. Not least, fiber breakage of the transportation textile can result in paint defects, which is because a particle which is more than 10 μm in cross section swells to 40 μm as a result of overpainting and consequently leads to a visible defect. The return rate in the above-mentioned process of painted bumpers which have to be reworked in the paint shop is on average 30%.

Further known technical packagings are polyolefin-based nonwovens, produced by the flashspun method. As a condition of manufacturing, these nonwovens have fibers of a length of a few centimeters and in principle they satisfy all requirements for scratch and soiling protection and can be rendered printable by surface-tension-increasing treatment (plasma, corona, etc). However, a disadvantage of these nonwovens is that they exhibit significant wear during continuous use, which restricts their reuse (mostly disposable items). Furthermore, limits are imposed on them in respect of mechanical load-bearing capacity and abrasion resistance. Finally, it is a disadvantage that polyolefins cannot be recycled, apart from being thermally recycled.

It is also known to use microfilament nonwovens having an average titer of from 0.2 dtex to 2 dtex as technical packagings. Although these nonwovens prove to be protective in respect of surfaces which are susceptible to scratches, for the most part they have to be discarded after a few cycles of use because they are not sufficiently resistant to pilling and abrasion (e.g. fiber breakage during insertion and removal of heavy transported goods, such as car doors).

### SUMMARY

An aspect of the invention provides a method of packaging an material, the method comprising: contacting the material with a technical packaging material surface layer comprising a microfilament fabric comprising a layer A comprising a) melt-spun microfilaments laid down to produce a nonwoven, bonded by jets of fluid, having an average titer of less than 0.15 dtex, and/or b) melt-spun composite filaments laid down to produce a nonwoven and are split and bonded by jets of fluid, at least to some extent to produce elementary filaments having an average titer of less than 0.15 dtex.

### DETAILED DESCRIPTION

An aspect of the invention is to provide a technical packaging material, in particular for protection during assembly and transportation, which overcomes at least some of the aforementioned disadvantages. In particular, the packaging material should exhibit adequate protection against external mechanical stress and at the same time, it should exhibit good continuous use properties, in particular a high resistance to abrasion and pilling, so that it can be used multiple times in an environmentally protective manner and less intensively in terms of reinvestment.

An aspect of the invention provides a microfilament fabric comprising at least one layer A which comprises
a) melt-spun microfilaments which are laid down to produce a nonwoven and are bonded by jets of fluid, in particular water jets, and have an average titer of less than 0.15 dtex, preferably less than 0.1 dtex, more preferably from 0.03 dtex to 0.06 dtex, and/or
b) melt-spun composite filaments which are laid down to produce a nonwoven and are split and bonded by jets of fluid, in particular water jets, at least to some extent to produce elementary filaments having an average titer of less than 0.15 dtex, preferably less than 0.1 dtex, more preferably from 0.03 dtex to 0.06 dtex,
   as the surface layer in a technical packaging material.

According to an aspect of the invention, it has surprisingly been found that the microfilament fabric which is used according to an aspect of the invention and contains very fine microfilaments or elementary filaments is outstandingly suitable as a surface layer in a technical packaging material and, in this respect, exhibits very good protection against surface stress, such as pilling and abrasion. In this respect, the layer A expediently faces and/or contacts the article to be packaged.

The fact that the microfilament fabric can be used as the surface layer in a technical packaging material was surprising in that it was expected that the very fine microfilaments or elementary filaments used in the microfilament fabric would result in very poor abrasion properties. “Abrasion” is understood to mean the removal of material, as a result of which the abraded product becomes increasingly thinner in the abraded area due to the removal of abrasion dust, culminating in the formation of a hole. The hole formation is an absolute measurement and can therefore be used to determine the abrasion resistance (ISO 12947-2 taken from the Martindale method, BS 5690). The previous general experience was that with a given material, the abrasion resistance decreases with the fiber titer. This is also obvious, if it is imagined that an abrasive procedure on a thick yarn initially only produces a notch, whereas in the case of a yarn having a smaller diameter, the same notch depth can lead to a break in the fiber.

Furthermore, it has surprisingly been found that the microfilament fabric is also distinguished by outstanding pilling properties. “Pilling” is understood to mean a loop in the surface of the fabric being hooked by an adjoining surface due to a surface roughness and, over time, the thread being pulled out of the fabric structure. This mostly happens with the formation of a ball, a so-called small pilling ball. If the thread consists of more of a crystalline or fragile material (e.g. cotton), the pilling ball can break off and consequently, the surface can look relatively intact again, even after an initial pilling appearance. However, the plastics materials which are usually used to produce microfiber nonwovens, for example polyester and polyamide small pilling balls, do not break off, as a result of which the balls become larger and the surface aspect deteriorates. However, according to an aspect of the invention, it has surprisingly been found that improved pilling values can be achieved by reducing the fiber titer (while retaining the weight per unit area and polymer composition). Thus, it has been found that the pilling resistance of polyethylene terephthalate/polyamide 6 (PET/PA6), 70/30, PIE16, 0.2 dtex filaments approximately doubles to produce PET/PA6, 70/30, PIE32, 0.1 dtex filaments.

According to an aspect of the invention, without wishing to commit to one mechanism, it is assumed that the outstanding pilling properties of the microfilament fabric are due to the fact that the very fine microfilaments or elementary filaments can be interlaced particularly effectively due to their relatively low flexural rigidity during the splitting and bonding step by means of fluid-jet bonding, in particular by hydroentanglement, as a result of which the internal friction in the fabric increases and the pilling resistance is improved.

According to an aspect of the invention, “a technical packaging material” is understood to mean a material which is used to partly or completely encase an article, in particular in order to protect it, and in particular to protect it during assembly and transportation, or for improved handling. In this respect, the packaging material should substantially ensure adequate protection of the article against external mechanical stress and also against particles of dirt and/or liquids.

It has been found in practical tests that the pilling and abrasion properties can be further improved by compacting the microfilament fabric to a greater extent. This can be achieved by increasing the energy introduced into the surface during the bonding step.

According to an aspect of the invention, layer A comprises microfilaments having an average titer of less than 0.15 dtex and/or composite filaments which are at least partly split to produce elementary filaments having an average titer of less than 0.15 dtex. Composite filaments can also be considered as a type of microfilament and can therefore form a microfilament fabric.

According to an aspect of the invention, the term “filaments” is understood to mean fibers which, in contrast to staple fibers, have a theoretically unlimited length. Composite filaments consist of at least two elementary filaments and can be split into elementary filaments and bonded by customary splitting methods, such as fluid-jet bonding. According to an aspect of the invention, the composite filaments of layer A are at least partly split into elementary filaments. In this respect, the degree of splitting is advantageously more than 80%, more preferably more than 90% and in particular approximately 100%.

In a preferred embodiment of the invention, the content of microfilaments and/or of elementary filaments of layer A is from 80 wt. % to 100 wt. %, preferably from 90 wt. % to 100 wt. %, in particular approximately 100 wt. %, in each case based on the total weight of layer A.

In the case of a microfilament composite fabric, the content of microfilaments and/or of elementary filaments of layer A, based on the total weight of the microfilament composite fabric, is preferably at least 5 wt. %, for example from 5 wt. % to 30 wt. % and/or from 5 wt. % to 25 wt. %.

According to an aspect of the invention, the microfilament fabric comprises at least one layer A as the surface layer and, in a simple embodiment of the invention, the microfilament fabric consists only of layer A. However, to optimize the properties, it can be advantageous to integrate layer A into a multi-layered material (composite fabric). In this case, it is advantageous in respect of continuous use properties (pilling and abrasion) if at least one outer layer of the microfilament composite fabric is formed by layer A. In this respect, it is also advantageous if layer A faces and/or contacts the article to be packaged.

In principle, it is conceivable that layer A also contains further fibers, for example metallized fibers, in addition to the microfilaments and/or elementary filaments. These fibers are advantageous for effective electrostatic discharge, right up to electrical conductivity. However, particularly good use properties are obtained when, as mentioned above, the content of microfilaments and/or elementary filaments in layer A amounts to at least 80 wt. %.

An advantage of using composite filaments as the starting material to produce the elementary filaments is that the titer of the elementary filaments produced therefrom can be easily adjusted by varying the number of the elementary filaments contained in the composite filaments. Here, the titer of the composite filaments can remain constant, which is advantageous from a procedural point of view. A further advantage of using the composite filaments is also that by varying the degree of splitting of the composite filaments, it is possible to easily control the ratio of relatively thick and relatively thin filaments in the microfilament composite fabric.

Practical tests have shown that microfilament fabrics having a particularly high abrasion resistance combined with good use properties can be obtained when the average titer of the microfilaments and/or of the elementary filaments of layer A is from 0.01 to 0.15 dtex, preferably from 0.01 to 0.1 dtex, in particular from 0.03 dtex to 0.06 dtex. Elementary filaments having this titer can be obtained, for example, by splitting composite filaments having a titer of 1 to 6.4 dtex, preferably from 1.2 to 3.8 dtex.

In this respect, the elementary filaments can be formed in the shape of a segment of a circle, or n-angled or multi-lobally in cross section.

The microfilament fabric is preferably one in which the composite filaments have a cross section having a multi-segmented structure like orange segments, also known as “pie”, where the segments can contain different, alternating, incompatible polymers. Hollow pie structures are also suitable, which can also have an asymmetrically axially extending cavity. Pie structures, in particular hollow pie structures, can be split particularly easily.

In this respect, the pie arrangement advantageously has 2, 4, 8, 16, 24, 32, 48 or 64 segments, particularly preferably 16, 24, 32 or 48 segments.

To achieve easy splitability, it is advantageous if the composite filaments contain at least two thermoplastic polymers. The composite filaments preferably comprise at least two incompatible polymers. The term “incompatible polymers” is understood to mean polymers which, when combined, produce non-adhering, partially or difficultly adhering pairings. A composite filament of this type has good splitability into elementary filaments and produces a favorable ratio of strength to weight per unit area. Partially or difficultly adhering pairings are present when the composite filaments having these pairings split more easily than in the case of a composite filament which consists of only one of the polymers used.

Polyolefins, polyesters, polyamides and/or polyurethanes are preferably used as incompatible polymer pairs in such a combination that non-adhering, partially or difficultly adhering pairs are produced.

The polymer pairs which are used are particularly preferably selected from polymer pairs having at least one first polyolefin, preferably polypropylene, and/or at least one polyamide, preferably polyamide 6, on the one hand, and at least one second polyolefin, preferably polypropylene or at least one polyester, preferably polyethylene terephthalate, on the other hand.

Polymer pairs having polypropylene, such as polypropylene/polyethylene, polypropylene/polyamide 6, and/or polypropylene/polyethylene terephthalate are particularly preferred.

Polymer pairs having at least one polyester, preferably polyethylene terephthalate and/or at least one polyamide, preferably polyamide 6, are also particularly preferred.

Polymer pairs having at least one polyamide and/or having at least one polyethylene terephthalate are preferably used due to their limited adhesiveness and polymer pairs having at least one polyolefin are particularly preferably used due to their poor adhesiveness.

The following have proven to be particularly expedient as particularly preferred components: polyesters, preferably polyethylene terephthalate, polylactic acid and/or polybutylene terephthalate, on the one hand, polyamide, preferably polyamide 6, polyamide 66, polyamide 46, on the other hand, optionally combined with one or more further polymers that are incompatible with the above-mentioned components, preferably selected from polyolefins. This combination has outstanding splitability. The combination of polyethylene terephthalate and polyamide 6 or of polyethylene terephthalate and polyamide 66 is very particularly preferred.

Options for producing microfilament layers of split composite filaments are known to a person skilled in the art and are described, for example, in EP 0814188 A1 and EP 1619283 A1.

It is also conceivable in principle that layer A is surface-treated and/or has a coating, for example a PVC coating. However, in a preferred embodiment of the invention, layer A does not have a coating, in particular it does not have a PVC coating. It is an advantage of this embodiment that the evaporation of gases and vapors from packaged articles is not hindered.

The weight per unit area of layer A can vary depending on the materials used and on the desired properties of the packaging material. Weights per unit area within a range of from 5 g/m² to 150 g/m², preferably from 10 g/m² to 100 g/m², more preferably from 10 g/m² to 50 g/m² have generally proved favorable.

The thickness of layer A can also vary depending on the materials used and on the desired properties of the packaging material. Thicknesses of at least 0.1 mm, for example from 0.1 mm to 1 mm, preferably from 0.2 mm to 0.8 mm and in particular from 0.3 mm to 0.5 mm, have generally proved favorable.

According to an aspect of the invention, the microfilament fabric preferably has a pilling, measured according to DIN 53867, of a note of at least 4, preferably of more than 4.5, at least on the side facing the article to be packaged.

Likewise, the microfilament fabric preferably has a Martindale abrasion (9 kPa), measured according to EN 12947, of at least 35,000 cycles, preferably of more than 40,000 cycles, at least on the side facing the article to be packaged.

In a particularly preferred embodiment of the invention, the microfilament fabric is used as protection during assembly and/or transportation, in particular for superficially delicate articles, such as painted car body parts, painted furniture, paintings, glasses, glass lenses, containers which are chrome-plated or are otherwise finished with a high gloss.

In a further particularly preferred embodiment of the invention, the microfilament fabric is used as protection during transportation of transported goods which subsequently release vapor, for example painted components or foodstuffs, such as bread or vegetables. Here, breathability or another gas or vapor exchange can be achieved by means of the construction according to an aspect of the invention, as well as simultaneous protection against dust, and even protection against pollen or other allergens.

The microfilament fabric can be in all kinds of forms which are favorable for the relevant intended use. Thus, the microfilament fabric can be used as sheet material, for example as an intermediate layer for stackable goods. In a preferred embodiment, the packaging material is designed as an envelope and/or pouch. In this respect, the envelope and/or pouch is expediently adapted to the shape and dimensions of the articles to be packaged. Consequently, the packaging material can be fixed particularly effectively on the articles and at the same time can provide them with a scratch-resistant stackability.

In a particularly preferred embodiment of the invention, the envelope and/or pouch has carrying loops and/or eyelets for receiving supporting rods, which is particularly advantageous for use as a suspended transportation protection.

For the use according to an aspect of the invention as a packaging material, the microfilament fabric can be used as such. However, it is also conceivable that at least one further layer is arranged on the side of layer A remote from the material to be packaged, as a result of which a microfilament composite fabric which is used according to an aspect of the invention is formed.

In a preferred embodiment of the invention, the microfilament composite fabric comprises, in addition to layer A, at least one layer B, preferably a layer B which has a strike-/impact-damping effect. It is an advantage of this embodiment that damage to the packaged materials can be prevented particularly effectively due to the additional damping layer. Furthermore, the layer B can have an electrostatic discharge effect, a vibration-damping effect and/or a high strength.

In a particularly preferred embodiment of the invention, layer B is of such a strength that the microfilament composite fabric has a maximum tensile force, measured according to DIN EN 13934-1, of more than 400 N/5 cm, for example of from 400 N/5 cm to 3000 N/5 cm, more preferably from 600 N/5 cm to 3000 N/5 cm and in particular of 700 N/5 cm to 3000 N/5 cm. This has the advantage that relatively heavy materials can also be packaged and transported using the packaging material.

A person skilled in the art has various options for combining layer A with layer B. For example, layer B can be processed in-line during the process. In this embodiment, for example after spinning and stretching, layer A can be laid directly onto layer B. Thereafter, it can pass through the further method steps together with layer A. Alternatively, layers A and B can only be brought together immediately before a hydroentanglement and/or splitting process and they can pass through these processes together. These embodiments are particularly expedient if layer B is a preferably unrollable fabric which has an air permeability of >80 l/m²s at 100 Pa, measured according to ISO 9237, and is preferably not destroyed at high hydroentanglement pressures and also does not dissolve in water. It is also conceivable to only combine layer A with layer B after a fluid-jet bonding step. For this purpose, it is possible to use usual bonding methods, for example sewing, adhesive bonding, welding etc.

In addition to layers A and B, the microfilament composite fabric can also comprise further layers, for example further layers A and/or B or also other layers (C). Thus, the packaging material can have the layer sequence ABA, for example.

To avoid repetition, reference is also made to the embodiments described in the following with regard to the technical packaging material claimed according to an aspect of the invention to describe particularly preferred embodiments of the microfilament fabric and/or microfilament composite fabric used according to an aspect of the invention, and in particular to describe particularly preferred embodiments of layers A and B.

An aspect of the present invention also relates to a technical packaging material, comprising a microfilament composite fabric which has
at least one surface layer A which comprises
a) melt-spun microfilaments which are laid down to produce a nonwoven and are bonded by jets of fluid, in particular water jets, and have an average titer of less than 0.15 dtex, preferably less than 0.1 dtex, more preferably from 0.03 dtex to 0.06 dtex, and/or
b) melt-spun composite filaments which are laid down to produce a nonwoven and are split and bonded by jets of fluid, in particular water jets, at least to some extent to produce elementary filaments having an average titer of less than 0.15 dtex, preferably less than 0.1 dtex, more preferably from 0.03 dtex to 0.06 dtex, and
at least one layer B which is of such a strength that the microfilament composite fabric has a maximum tensile force, measured according to DIN EN 13934-1, of more than 400 N/5 cm.

To avoid repetition, reference is also made to the embodiments described above with regard to the use claimed according to an aspect of the invention to describe particularly preferred embodiments of the microfilament composite fabric, and in particular to describe particularly preferred embodiments of layers A and B.

The technical packaging material according to an aspect of the invention has at least one layer B which is of such a strength that the microfilament composite fabric has a maximum tensile force, measured according to DIN EN 13934-1, of more than 400 N/5 cm. As stated above, this has the advantage that relatively heavy materials can also be packaged and transported using the packaging material.

In a particularly preferred embodiment of the invention, layer B is of such a strength that the microfilament composite fabric has a maximum tensile force, measured according to DIN EN 13934-1, of from 400 N/5 cm to 3000 N/5 cm, more preferably from 600 N/5 cm to 3000 N/5 cm and in particular from 700 N/5 cm to 3000 N/5 cm.

In practical tests, it has proven to be favorable if layer B contains one or more of the following products and/or if it consists thereof: open-pore and preferably viscoelastic foams, perforated films, reticulated textile fabrics, nonwovens, woven fabrics, interlooped fabrics, knitted fabrics and/or spacer fabrics. These products can consist of all kinds of materials, provided that layer B exhibits a strength as described above.

The weight per unit area of the microfilament composite fabric can vary depending on the specific areas of use. It has proven to be favorable for many cases to adjust the weight per unit area of the microfilament composite fabric to values of from 80 g/m² to 280 g/m², preferably from 100 g/m² to 250 g/m², and in particular from 100 g/m² to 250 g/m².

In addition to layers A and B, the microfilament composite fabric according to an aspect of the invention can also comprise further layers, for example further layers A and/or B or also other layers (C). Thus, the packaging material can have the layer sequence ABA, for example. In this embodiment, both surfaces of the packaging material exhibit the advantageous properties discussed above in respect of layer A. Consequently, simple, material-saving and cost-effective production is possible which nevertheless ensures optimum protection of the packaged material.

The following layers C, for example, are possible as further layers: electrically conductive, and/or resilient and/or pre-impregnated and/or hot-air-shrinkable, air-permeable fabrics.

As described above, the microfilament composite fabric is distinguished by outstanding mechanical properties, such as high durability and good abrasion resistance, paired with good protection of delicate surfaces.

Advantageously, the microfilament composite fabric is further characterized by an easily adjustable tear propagation force according to DIN EN ISO 155797.

The thickness of the microfilament composite fabric can also vary depending on the materials used and on the desired properties of the technical packaging material. In general, thicknesses in the region of more than 0.3 mm, for example from 0.3 mm to 20 mm, preferably from 1 to 5 mm, more preferably from 2 to 4 mm have proven favorable.

The technical packaging material according to an aspect of the invention can be produced as follows, for example:
at least one layer A is provided which comprises
a) melt-spun microfilaments which are laid down to produce a nonwoven and are bonded by jets of fluid, in particular water jets, and have an average titer of less than 0.15 dtex, preferably less than 0.1 dtex, more preferably from 0.03 dtex to 0.06 dtex, and/or
b) melt-spun composite filaments which are laid down to produce a nonwoven and are split and bonded by jets of fluid, in particular water jets, at least to some extent to produce elementary filaments having an average titer of less than 0.15 dtex, preferably less than 0.1 dtex, more preferably from 0.03 dtex to 0.06 dtex;
at least one layer B is provided which exhibits such a strength that the resulting microfilament composite fabric has a maximum tensile force, measured according to DIN EN 13934-1, of more than 700 N/5 cm;
layers A and B are arranged one on top of the other, at least one surface layer being formed by layer A;
layers A and B are joined together, thereby forming a microfilament composite fabric.

A method in which layer(s) A and B are produced separately and are joined together by known joining methods, for example by hydroentanglement and/or by adhesive bonding, has proven to be particularly simple.

In the following, an aspect of the invention will be described in more detail based on a plurality of non-restrictive examples:

### Example 1: Production of a Microfilament Fabric which can be Used According to an Aspect of the Invention and of a Comparative Fabric

In the following, the production of nonwovens is described using a bicomponent spunbond plant from bicomponent filaments having a “pie”-form cross section.

A nonwoven which can be used according to an aspect of the invention and comprises 32 individual filaments (“PIE32”) having a weight per unit area of 240 g/m² is compared with a nonwoven which is identical, but is based on PIE16, in an identical mode of production.

### Raw Materials: Content:

### Polyester, 70

### Polyamide 6, 30

### Extruders:

### PET, Zones 1-7 270-295° C.

### PA6, Zones 1-7 260-275° C.

### Spinning Pumps:

Total throughput 1.3 g/L per min
Polymer ratio outside, splittable layers: PET/PA6, 71/29 (vol. %) central, 110 g/m², unsplittable: PET/PA6, >90/<10 (vol.)

### Nozzles:

Nozzle type Reference PIE16, according to an aspect of the invention PIE32
Stretch pneumatically, 5000-5500 m/min

### Laying:

Laying is carried out on a laydown belt at a preset speed which produces a weight per unit area of 240 g/m².

### Bonding:

Prebonding is carried out by needling with 35 stitches/cm² and subsequent calendaring using steel rolls smooth/smooth. The final bonding and the splitting of the splittable filaments is carried out by hydroentanglement with 4 to 6 alternating passages on the upper side A and on the lower side B of the nonwoven in the sequence ABAB(AB).

### Drying:

The nonwoven is dried and heat-set at 190° C. using a cylindrical through-air dryer.

The production rate depends on the desired weight per unit area.

Two identical nonwovens are produced under identical conditions which, in respect of layer A, differ only by the use of PIE 16 and PIE 32 nozzles.

### Example 2: Comparison of Various Relevant Parameters of the Microfilament Fabric Produced in Example 1

Various properties, relevant to the use according to an aspect of the invention as packaging material, of the microfilament fabric produced in Example 1 are examined using appropriate measurement methods. The tests are based on the following standards in the versions which were valid on the application date, unless indicated otherwise:

| Property | Unit | Standard |
|---|---|---|
| Weight per unit area | g/m² | EN 965 |
| Thickness | mm | EN 964-1 |
| Maximum tensile force | N/5 cm | EN 13934-1 |
| Maximum tensile | % | EN 13934-1 |
| elongation | | |
| Tear propagation force | N | EN 13937-2 |
| Pilling | Note | Based on DIN 53867 |
| Martindale abrasion | cycles | EN 12947 |
| (9 kPa) | | |

The parameters shown in the following Table were found:

| PIE-Types | | | PIE16 | PIE32 |
|---|---|---|---|---|
| Weight per unit area | | (g/m²) | 237 | 239 |
| Thickness | | (mm) | 0.83 | 0.81 |
| Maximum tensile force | L | (N/5 cm) | 770 | 745 |
| | Q | (N/5 cm) | 880 | 863 |
| Maximum tensile | L | (%) | 49 | 47.5 |
| elongation | | | | |
| | Q | (%) | 53 | 54 |
| Delamination resistance | L | N/5 cm | 16 | 19 |
| Tear propagation strength | L | (N) | 40 | 38 |
| | Q | (N) | 44 | 41 |
| Pilling | | (above/ | 3/3 | 4/4.5 |
| | | below) | | |
| Martindale abrasion | | Hole at | 25000 | 45000 |
| resistance 9 kPa | | | | |

The Table shows that when changing from PIE16 to PIE32, i.e. with a decreasing fiber titer, the following changes occur:

a significant increase in the delamination resistance

a very strong increase in the abrasion resistance

a very strong increase in the pilling resistance.

These changes in properties show that the microfilament fabric according to an aspect of the invention which contains very fine microfilaments is outstandingly suitable as a technical packaging material and at the same time, affords very good protection against external mechanical stress, and also exhibits very good abrasion resistance.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A method of packaging a material, the method comprising: contacting
the material with a technical packaging material surface layer comprising a microfilament fabric comprising a layer A comprising
a) melt-spun microfilaments laid down to produce a nonwoven, bonded by jets of fluid, having an average titer of less than 0.15 dtex, and/or
b) melt-spun composite filaments laid down to produce a nonwoven and are split and bonded by jets of fluid, at least to some extent to produce elementary filaments having an average titer of less than 0.15 dtex.

2. The method of claim 1, wherein the jets include a water jet.

3. The method of claim 1, wherein content of microfilaments and/or elementary filaments of layer A is from 80 wt. % to 100 wt. %, based on a total weight of layer A.

4. The method of claim 1, wherein the layer A does not have a coating on a side facing the material to be packaged.

5. The method of claim 1, wherein the layer A does not have a a PVC coating, on a side facing the material to be packaged.

6. The method of claim 1, wherein the layer A has a thickness of from 0.1 mm to 1 mm.

7. The method of claim 1, wherein the microfilament fabric has a pilling, measured according to DIN 53867, which corresponds to a note of at least 4 at least on a side facing the material to be packaged.

8. The method of claim 1, further comprising:
protecting the material with the microfilament fabric during assembly and/or transportation.

9. The method of claim 8, wherein the material comprises a painted car body part, painted furniture, painting, glasses, glass lens, chrome-plated container, or a finished container.

10. The method of claim 8, wherein the material protected is subject to transport and subsequently releases vapor post transportation.

11. The method of claim 1, further comprising:
forming the microfilament fabric into a sheet material, an envelope, and/or a pouch.

12. The method of claim 1, wherein the microfilament fabric is formed as a microfilament composite fabric which comprises a further layer on the side of layer A remote from the material to be packaged.

13. The method of claim 12, wherein, in the microfilament composite fabric, layer A faces and/or contacts the material to be packaged.

14. The method of claim 12, wherein the microfilament composite fabric further comprises a layer B which exhibits such a strength that the microfilament composite fabric has a maximum tensile force, measured according to DIN EN 13934-1, of more than 400 N/5 cm.

15. The method of claim 12, wherein a content of the microfilaments and/or elementary filaments of layer A, based on a total weight of the microfilament composite fabric, is at least 5 wt. %.

16. A technical packaging material, comprising a microfilament composite fabric comprising a surface layer A which comprises
a) melt-spun microfilaments laid down to produce a nonwoven and bonded by jets of fluid, having an average titer of less than 0.15 dtex, and/or
b) melt-spun composite filaments laid down to produce a nonwoven and split and bonded by jets of fluid at least to some extent to produce elementary filaments having an average titer of less than 0.15 dtex, and
a layer B which exhibits such a strength that the microfilament composite fabric has a maximum tensile force, measured according to DIN EN 13934-1, of more than 400 N/5 cm.

17. A method of producing the microfilament composite fabric of claim 16, the method comprising:
providing at least one layer A comprising
a) melt-spun microfilaments laid down to produce a nonwoven and bonded by jets of fluid, having an average titer of less than 0.15 dtex, and/or
b) melt-spun composite filaments laid down to produce a nonwoven and split and bonded by jets of fluid at least to some extent to produce elementary filaments having an average titer of less than 0.15 dtex;
providing a layer B which exhibits such a strength that the microfilament composite fabric has a maximum tensile force, measured according to DIN EN 13934-1, of more than 400 N/5 cm,
arranging layers A and B one on top of the other, thereby forming at least one surface layer by the layer A; and
joining the layers A and B together, thereby forming the microfilament composite fabric.

18. The method of claim 1, wherein the layer A comprises a) the melt-spun microfilaments.

19. The method of claim 1, wherein the layer A comprises b) the melt-spun composite filaments.

20. The method of claim 1, wherein the layer A comprises
a) the melt-spun microfilaments; and
b) the melt-spun composite filaments.
